(19) United States
(12) Patent Application Publication
(10) Pub. No.: US 2024/0210273 A1
(43) Pub. Date: Jun. 27, 2024

(54) Photochromic Lens Demonstration Unit

(71) Applicant: Transition Optical, Ltd., Tuam (IE)

(72) Inventors: Christopher J. Baldy, Murrysville, PA (US); William D. Carpenter, Tuam (IE)

(21) Appl. No.: 18/557,629

(22) PCT Filed: Apr. 29, 2021
(86) PCT No.: PCT/EP2021/061219

§ 371 Date: Oct. 27, 2023

(51) Int. Cl. G01M 11/02; G09B 23/22

(52) U.S. Cl. CPC G01M 11/0207; G01M 11/0285; G09B 23/22

(57) ABSTRACT

A demonstration unit for demonstrating at least one photochromic characteristic of an optical article having at least one photochromic material includes a housing defining an interior, at least two activating light sources configured to radiate ultraviolet light into the interior, at least one visible light source configured to illuminate at least a portion of the interior of the housing. and a control device operatively connected to the at least two activating light sources and the at least one visible light source. The control device is configured to control operation of the activating light sources and the visible light source to activate at least one photochromic compound of the photochromic material based on at least one predetermined spectral profile corresponding to a simulated outdoor lighting condition. A method of demonstrating at least one photochromic characteristic of an optical article having a photochromic material using the demonstration unit is also disclosed.

### BACKGROUND OF THE DISCLOSURE

### Field of the Disclosure

The present disclosure relates generally to a demonstration unit for demonstrating one or more characteristics of optical articles, and more particularly, to a demonstration unit for demonstrating photochromic characteristics of optical articles having a photochromic material.

### Description of Related Art

With optical articles, such as lenses, the optical article may be subjected to a treatment to enhance the overall performance and function of the optical article. Examples of such treatments include the formation of one or more coatings on a surface of an optical substrate. For example, the coating could include one or more photochromic materials. Optical articles having a photochromic material are configured to transition from an unactivated, or substantially colorless state, to an activated, or colored state in response to exposure to certain wavelengths of electromagnetic radiation (or “actinic radiation”). In the absence of exposure to actinic radiation, photochromic compound(s) in such photochromic materials are reversibly transformed from the activated (colored) state, back to the unactivated (colorless) state. Generally, the reversible transformation of a photochromic compound from the unactivated (colorless) state to the activated (colored) state is faster than the transformation from the activated (colored) state to the unactivated (colorless) state.

When demonstrating the reversible transformation of photochromic lenses, such as when an optician is advising a customer, an activating light source can be used to activate the photochromic compound(s) and transform the lens from a colorless state to a colored state. This transformation occurs relatively quickly (e.g., 5 to 30 seconds) such that the transformative effect can be easily and quickly demonstrated. However, activating the photochromic compound(s) of a photochromic lens in an indoor setting does not adequately portray how the lens will appear in various outdoor lighting conditions, such as on a sunny day or a cloudy day. Therefore, it would be desirable to provide a demonstration unit and/or a method for demonstrating the photochromic characteristic of photochromic lenses to more accurately show the lens appearance in outdoor lighting conditions.

### SUMMARY OF THE DISCLOSURE

In accordance with some examples or aspects of the present disclosure, provided is a demonstration unit for demonstrating at least one photochromic characteristic of an optical article having at least one photochromic material. The demonstration unit may include a housing defining an interior; at least two activating light sources configured to radiate ultraviolet light into the interior of the housing; at least one visible light source configured to illuminate at least a portion of the interior of the housing; and a control device operatively connected to the at least two activating light sources and the at least one visible light source. The control device may be configured to control operation of the at least two activating light sources and the at least one visible light source to activate at least one photochromic compound of the at least one photochromic material based on at least one predetermined spectral profile corresponding to a simulated outdoor lighting condition.

In accordance with some examples or aspects of the present disclosure, the at least one predetermined spectral profile corresponding to the simulated outdoor lighting condition may be generated by individually controlling each of the at least two activating light sources and the at least one visible light source. The control device may be configured to control an activation of the at least two activating light sources and the at least one visible light source, and/or an intensity of the at least two activating light sources and the at least one visible light source.

In accordance with some examples or aspects of the present disclosure, each of the at least two activating light sources may be configured to emit a different spectral output in an ultraviolet light spectrum. Each of the at least two activating light sources may be an ultraviolet light emitting diode.

In accordance with some examples or aspects of the present disclosure, a light sensing device may be operatively connected with the control device, wherein the control device is configured to control operation of the at least two activating light sources and the at least one visible light source based on light characteristics sensed by the light sensing device. The light sensing device may be a photodiode.

In accordance with some examples or aspects of the present disclosure, an inspection platform may be provided within the interior of the housing configured for supporting at least a portion of the optical article.

In accordance with some examples or aspects of the present disclosure, at least one heating device may be configured to heat at least a portion of the interior of the housing. The at least one heating device may include at least one heat source and at least one fan.

In accordance with some examples or aspects of the present disclosure, the housing may include a door for enclosing the interior of the housing.

In accordance with some examples or aspects of the present disclosure, a method of demonstrating at least one photochromic characteristic of an optical article having at least one photochromic material may be provided. The method may include receiving the optical article within an interior of a housing of a demonstration unit; activating at least one activating light source to irradiate at least a portion of the optical article with ultraviolet light; activating at least one visible light source to irradiate at least a portion of the optical article with visible light; and controlling, using a control device, operation of the at least two activating light sources and the at least one visible light source to activate a photochromic compound of the at least one photochromic material based on at least one predetermined spectral profile corresponding to a simulated outdoor lighting condition.

In accordance with some examples or aspects of the present disclosure, controlling the operation of the at least two activating light sources and the at least one visible light source may include individually controlling an activation of the at least two activating light sources and the at least one visible light source, and an intensity of the at least two activating light sources and the at least one visible light source of the at least two activating light sources and the at least one visible light source.

In accordance with some examples or aspects of the present disclosure, the method further may include heating at least a portion of the interior of the housing with a heating device.

A demonstration unit for demonstrating at least one photochromic characteristic of an optical article having at least one photochromic material and a method of demonstrating at least one photochromic characteristic of an optical article having at least one photochromic material may be characterized by one or more of the following aspects.

In a first aspect, the demonstration unit for demonstrating at least one photochromic characteristic of an optical article having at least one photochromic material may have a housing defining an interior; at least two activating light sources configured to radiate ultraviolet light into the interior of the housing; at least one visible light source configured to illuminate at least a portion of the interior of the housing; and a control device operatively connected to the at least two activating light sources and the at least one visible light source. The control device may be configured to control operation of the at least two activating light sources and the at least one visible light source to activate at least one photochromic compound of the at least one photochromic material based on at least one predetermined spectral profile corresponding to a simulated outdoor lighting condition.

In a second aspect, in the demonstration unit in accordance with the first aspect, the at least one predetermined spectral profile corresponding to the simulated outdoor lighting condition may be generated by individually controlling each of the at least two activating light sources and the at least one visible light source.

In a third aspect, in the demonstration unit in accordance with the first aspect or the second aspect, the control device may be configured to control an activation of the at least two activating light sources and the at least one visible light source.

In a fourth aspect, in the demonstration unit in accordance with any one of the first aspect to the third aspect, the control device may be configured to control an intensity of the at least two activating light sources and the at least one visible light source.

In a fifth aspect, in the demonstration unit in accordance with any one of the first aspect to the fourth aspect, each of the at least two activating light sources may be configured to emit a different spectral output in an ultraviolet light spectrum.

In a sixth aspect, in the demonstration unit in accordance with the sixth aspect, each of the at least two activating light sources may be an ultraviolet light emitting diode.

In a seventh aspect, in the demonstration unit in accordance with any one of the first aspect to the sixth aspect, the demonstration unit further may include a light sensing device operatively connected with the control device, wherein the control device may be configured to control operation of the at least two activating light sources and the at least one visible light source based on light characteristics sensed by the light sensing device.

In an eighth aspect, in the demonstration unit in accordance with the seventh aspect, the light sensing device may be a photodiode.

In a ninth aspect, in the demonstration unit in accordance with any one of the first aspect to the eighth aspect, the demonstration unit further may include an inspection platform within the interior of the housing configured for supporting at least a portion of the optical article.

In a tenth aspect, in the demonstration unit in accordance with any one of the first aspect to the ninth aspects, the demonstration unit further may include at least one heating device configured to heat at least a portion of the interior of the housing.

In an eleventh aspect, in the demonstration unit in accordance with the tenth aspect, the at least one heating device may include at least one heat source and at least one fan.

In a twelfth aspect, in the demonstration unit in accordance with any one of the first aspect to the eleventh aspect, the housing may include a door for enclosing the interior of the housing.

In a thirteenth aspect, a method of demonstrating at least one photochromic characteristic of an optical article having at least one photochromic material may be provided. The method may include receiving the optical article within an interior of a housing of a demonstration unit; activating at least one activating light source to irradiate at least a portion of the optical article with ultraviolet light; activating at least one visible light source to irradiate at least a portion of the optical article with visible light; and controlling, using a control device, operation of the at least two activating light sources and the at least one visible light source to activate a photochromic compound of the at least one photochromic material based on at least one predetermined spectral profile corresponding to a simulated outdoor lighting condition.

In a fourteenth aspect, in the method in accordance with the thirteenth aspect, controlling the operation of the at least two activating light sources and the at least one visible light source may include individually controlling an activation of the at least two activating light sources and the at least one visible light source, and an intensity of the at least two activating light sources and the at least one visible light source of the at least two activating light sources and the at least one visible light source.

In a fifteenth aspect, the method in accordance with the thirteenth aspect or the fourteenth aspect further may include heating at least a portion of the interior of the housing with a heating device.

The features that characterize the present disclosure are pointed out with particularity in the claims, which are annexed to and form a part of this disclosure. These and other features of the disclosure, its operating advantages, and the specific objects obtained by its use will be more fully understood from the following detailed description in which non-limiting examples of the disclosure are illustrated and described.

### BRIEF DESCRIPTION OF THE DRAWINGS

FIG. 1 is a top perspective view of a demonstration unit for demonstrating at least one photochromic characteristic of an optical article in accordance with some examples or aspects of the present disclosure;

FIG. 2 is a schematic side cross-sectional view of the demonstration unit of FIG. 1; and

FIG. 3 is a flow chart of a method for demonstrating at least one photochromic characteristic of an optical article in accordance with some examples or aspects of the present disclosure.

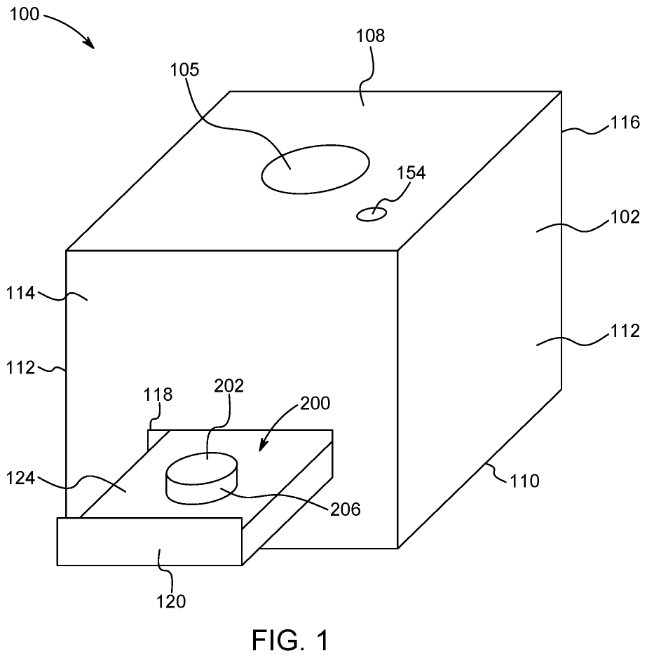

In FIGS. 1-3, like characters refer to the same components and elements, as the case may be, unless otherwise stated.

### DETAILED DESCRIPTION OF THE DISCLOSURE

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

All numbers used in the specification and claims are to be understood as being modified in all instances by the term “about”. By “about” is meant plus or minus twenty-five percent of the stated value, such as plus or minus ten percent of the stated value.

However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

As used herein, the term “optical” means pertaining to or associated with light and/or vision. For example, according to various non-limiting aspects disclosed herein, the optical element, article or device can be chosen from ophthalmic elements, articles, and devices, display elements, articles, and devices, windows, and mirrors.

As used herein, the term “ophthalmic” means pertaining to or associated with

the eye and vision. Non-limiting examples of ophthalmic articles or elements include corrective and non-corrective lenses, including single vision or multi-vision lenses, which may be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors.

As used herein, the terms “lens” and “lenses” mean and encompass at least individual lenses, lens pairs, partially formed (or semi-finished) lenses, fully formed (or finished) lenses, and lens blanks.

As used herein, the term “photochromic” and similar terms, such as “photochromic material” or “photochromic compound”, means any material or compound having an absorption spectrum for at least visible radiation that varies in response to absorption of at least actinic radiation. A photochromic material includes at least one photochromic compound. The photochromic material or compound may be incorporated into a coating or a film applied to at least one surface of an optical article. Additionally, or alternatively, the photochromic material or compound may be incorporated into the body of the optical article, such as by imbibition or casting into the material of the optical article. The term “photochromic lens” means a lens having a photochromic material associated therewith. The terms “photochromic coating” and “photochromic film” include thermally-reversible photochromic materials and compounds. The term “thermally-reversible photochromic compounds/materials” as used herein means compounds/materials capable of converting from a first state, for example a “colorless state”, to a second state, for example a “colored state”, in response to actinic radiation, and reverting back to the first state in response to thermal energy.

As used herein, the term “actinic radiation” means electromagnetic radiation that is capable of causing a response in a material, such as, but not limited to, transforming a photochromic material from one form or state to another as will be discussed in further detail herein.

As used herein, the terms “visible light” or “visible radiation” means electromagnetic radiation having a wavelength in the range of 380 nm to 780 nm.

As used herein, the terms “ultraviolet”, “ultraviolet radiation”, “ultraviolet light”, and “ultraviolet light spectrum” mean electromagnetic radiation having a wavelength in the range of 100 nm to less than 435 nm. The term “UV” means ultraviolet, such as ultraviolet radiation.

The discussion of various examples or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the various examples and aspects described herein.

As used herein, the terms “communication” and “communicate” may refer to the reception, receipt, transmission, transfer, provision, and/or the like, of information (e.g., data, signals, messages, instructions, commands, and/or the like).

As used herein, a “graphical user interface” or “GUI” refers to a generated display with which a user may interact, either directly or indirectly (e.g., through a button, keyboard, mouse, touchscreen etc.).

The disclosure comprises, consists of, or consists essentially of, the following examples or aspects, in any combination. Various examples or aspects of the disclosure are illustrated in separate drawing figures. However, it is to be understood that this is simply for ease of illustration and discussion. In the practice of the disclosure, one or more examples or aspects shown in one drawing figure can be combined with one or more examples or aspects shown in one or more of the other drawing figures.

With reference to FIG. 1, a demonstration unit 100 is shown in accordance with some examples or aspects of the present disclosure. The demonstration unit 100 may be configured for demonstrating at least one photochromic characteristic of an optical article having at least one photochromic material, such as an optical article 200 having at least one photochromic material, as described herein. The demonstration unit 100 may be configured as a portable device particularly suitable for use in an office environment. For example, the demonstration unit 100 can be configured as a portable, table-top device for use in a doctor's office or an eye-care store to demonstrate thermally-reversible photochromic characteristics of photochromic optical articles 200.

The optical article 200 can be selected from ophthalmic articles or elements, display articles or elements, windows, mirrors, active liquid crystal cell articles or elements, and passive liquid crystal cell articles or elements. Examples of ophthalmic articles or elements include, but are not limited to, corrective and non-corrective lenses, including single vision or multi-vision lenses, which can be either segmented or non-segmented multi-vision lenses (such as, but not limited to, bifocal lenses, trifocal lenses, and progressive lenses), as well as other elements used to correct, protect, or enhance (cosmetically or otherwise) vision, including without limitation, contact lenses, intra-ocular lenses, magnifying lenses, and protective lenses or visors.

With reference to FIG. 1, the optical article 200 has a forward or top surface 202, a rearward or bottom surface (not shown), and a side surface 206 extending between the top surface 202 and the bottom surface. When the optical article 200 is an ophthalmic lens, the bottom surface is opposed to the eye of an individual wearing the optical article 200, the side surface 206 typically resides within a supportive frame, and the top surface 202 faces incident light (not shown) at least a portion of which passes through the optical article 200 and into the individual's eye. The optical article 200 has at least one photochromic material configured to transition from an unactivated, or substantially colorless state, to an activated, or colored state in response to exposure to actinic radiation. The photochromic material may be applied to at least one surface of the optical article 200 in a coating or a film. Alternatively, or in addition, the photochromic material may be incorporated into the body of the optical article 200, such as by imbibition or prior to casting the optical article 200.

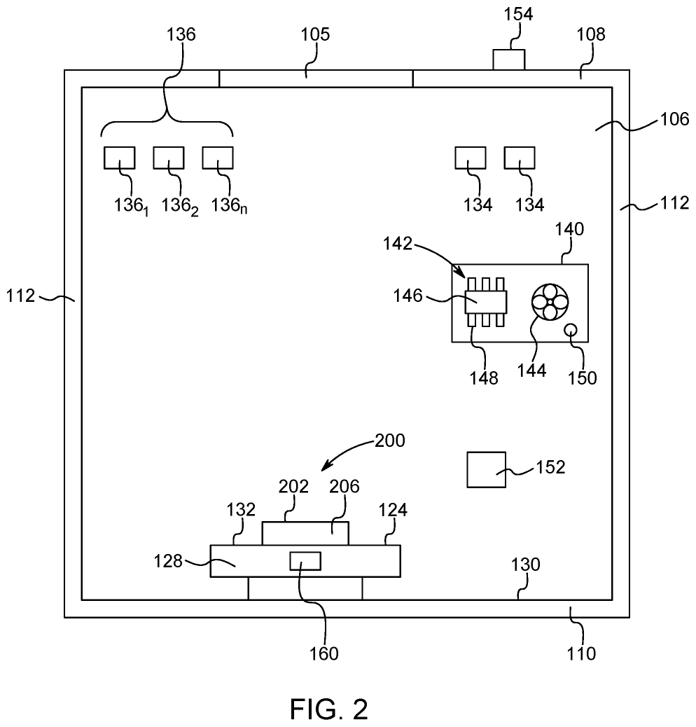

With reference to FIG. 1, the demonstration unit 100 includes a housing 102 having a sidewall 104 defining a hollow interior 106 (shown in FIG. 2). The housing 102 at least partially encloses the components of the demonstration unit 100. Some components of the demonstration unit 100 may be completely enclosed within the housing 102, as discussed herein. The housing 102 may be of any suitable rigid material, such as plastic or metal.

With continued reference to FIG. 1, the housing 102 includes a plurality of sides, including a top side 108 opposite a bottom side 110 with a pair of lateral sides 112, a front side 114, and a rear side 116 connected to each of the top side 108 and the bottom side 110. In some examples or aspects, the housing 102 is monolithically formed as a single, integral part. In other examples or aspects, the housing 102 is formed from a plurality of discrete parts that are removably or non-removably combined together. While the housing 102 shown in FIG. 1 has a substantially cuboid shape, the housing 102 may have any other shape.

In some examples or aspects, at least a portion of the sidewall 104 may be transparent to allow viewing of the housing interior 106 from the outside of the housing 102 through the sidewall 104. For example, the housing 102 may have a viewing opening 105 extending through the sidewall 104 of at least one side of the housing 102. The viewing opening 105 may be covered by a transparent cover made of plastic or glass. As used herein, “transparent” means permitting visible light to pass through without diffusing or scattering the light.

With continued reference to FIG. 1, the housing 102 may have at least one opening 118 providing access to the interior 106. The opening 118 may be formed in one or more of the sides of the housing 102. The opening 118 may be enclosed by a cover panel, a door, or a drawer 120. In some examples or aspects, the drawer 120 has an inspection platform 124 configured for supporting at least a portion of the optical article 200. In some examples or aspects, the drawer 120 may be movable between an open position, where the inspection platform 124 is moved to the outside of the housing 102 to permit loading and unloading of the optical article 200 onto the inspection platform 124, and a closed position, where the inspection platform 124 is moved into the interior of the housing 102. In some examples or aspects, the drawer 120 may be configured for sliding movement relative to the housing 102.

In some examples or aspects, the inspection platform 124 may be configured for supporting a plurality of optical articles 200. For example, a pair of optical articles 200 may be positioned side-by-side on the inspection platform 124. The inspection platform 124 may be offset relative to a lower interior surface 130 of the housing 102 (shown in FIG. 2). As shown in FIG. 2, the inspection platform 124 may have a viewing stand 128 defining a support surface 132 for supporting at least a portion of at least one optical article 200, such as the bottom surface of at least one optical article 200. The viewing stand 128 may be made from a transparent or translucent material. As used herein, “translucent” means permitting light to pass through but diffusing or scattering the light. A backlight (not shown) may be provided to light the viewing stand 128 from a bottom surface of the optical article 200.

With reference to FIG. 2, the demonstration unit 100 has at least one activating light source 136 configured to radiate electromagnetic radiation into the interior 106 of the housing 102. In some examples or aspects, the at least one activating light source 136 may be an actinic light source configured to radiate actinic electromagnetic radiation into the interior 106 of the housing 102. The at least one activating light source 136 may be configured for activating the photochromic compound(s) in the photochromic material of the optical article 200 due to exposure to actinic radiation emitted by the at least one activating light source 136. In some examples or aspects, the at least one activating light source 136 may be configured for emitting electromagnetic radiation within the ultraviolet spectrum, such as electromagnetic radiation having wavelength in the range of 355-435 nm. The at least one activating light source 136 may have one or more UV emitters, such as one or more conventional UV lamps and/or one or more UV light-emitting diodes (LEDs).

In some examples or aspects, the demonstration unit 100 has at least two activating light sources 136 configured to emit a different spectral output in an ultraviolet light spectrum. As shown in FIG. 2, the at least one activating light source 136 may be a plurality of activating light sources 136₁, 136₂, . . . 136n, wherein “n” is an integer number larger than 2. At least some of the plurality of activating light sources 136₁, 136₂, . . . 136n may be configured to emit a different spectral output in an ultraviolet light spectrum compared to other activating light sources of the plurality of activating light sources 136. For example, a first activating light source 136₁ may be configured to emit ultraviolet light in the range of 365-375 nm, a second activating light source 136₂ may be configured to emit ultraviolet light in the range of 410-420 nm, and a third activating light source 136₃ may be configured to emit ultraviolet light in the range of 390-400 nm.

In some examples or aspects, the at least one activating light source 136 may be mounted proximate to the top side of the housing 102 such that it directs UV radiation into the interior 106 from the top side of the housing 102. In other examples or aspects, the at least one activating light source 136 may be mounted proximate to the bottom side of the housing 102 such that it directs UV radiation into the interior chamber 106 from the bottom side of the housing 102. In further examples or aspects, the at least one activating light source 136 may be mounted to top, bottom, and/or lateral sides of the housing 102. In some examples or aspects, the at least one activating light source 136 may be configured for operating on a 12V DC power circuit. In other examples or aspects, the at least one activating light source 136 may be configured for operating on a 110V or a 220V AC power circuit, and/or on battery power. The at least one activating light source 136 may be fixedly or non-movably mounted on the housing 102.

With continued reference to FIG. 2, the demonstration unit 100 has at least one visible light source 134 configured for illuminating at least a portion of the interior of the housing 102. The at least one visible light source 134 may be configured for toning down the blue hue associated with the at least one activating light source 136 and providing a lighting intensity and coloration that accurately simulates outdoor lighting conditions. In some examples or aspects, the at least one visible light source 134 has a yellow overtone that mixes with the blue/violet overtone of the at least one activating light source 136 such that the combined light from the at least one visible light source 134 and the at least one activating light source 136 appears white. The at least one visible light source 134 is also configured to mask changes in intensity of the at least one activating light source. In this manner, the user will not notice changes in lighting as the at least one activating light source 136 switches from activating at least one photochromic compound of the optical article 200 to maintaining activation of the photochromic compound. In some examples or aspects, the at least one visible light source 134 may be configured for emitting electromagnetic radiation within the visible light spectrum.

In some examples or aspects, the at least one visible light source 134 may be mounted proximate to the top side of the housing 102 such that it directs light into the interior 106 from the top side of the housing 102. In other examples or aspects, the at least one visible light source 134 may be mounted proximate to the bottom side of the housing 102 such that it directs light into the interior chamber 106 from the bottom side of the housing 102. In further examples or aspects, the at least one visible light source 134 may be mounted to top, bottom, and/or lateral sides of the housing 102. The at least one visible light source 134 may be fixedly or non-movably mounted on the housing 102.

In some examples or aspects, the at least one visible light source 134 may be at least one of a fluorescent light source, a halogen light source, an incandescent light source, or an LED light source. The at least one visible light source 134 may be one or more bulbs, lamps, LEDs, and/or light bars/strips. In some examples or aspects, the at least one visible light source 134 may be configured for operating on a 12V DC power circuit, such as a 12V DC edge lit backlight. In other examples or aspects, the at least one visible light source 134 may be configured for operating on a 110V or a 220V AC power circuit, and/or on battery power.

With continued reference to FIG. 2, the demonstration unit 100 has at least one light sensing device 160 configured to control operation of the at least one visible light source 134 and the at least one activating light source 136 based on light characteristics sensed by the light sensing device 160. In some examples or aspects, the at least one light sensing device 160 may be configured for sensing irradiance. The at least one light sensing device 160 may be a photodiode that is configured to convert incident light energy into a corresponding current. In some examples or aspects, the at least one light sensing device 160 may be used to determine the darkness of the optical article 200. Information regarding the darkness of the optical article 200 may be used to control the activation and/or intensity of the at least one visible light source 134 and the at least one activating light source 136.

With continued reference to FIG. 2, the demonstration unit 100 has at least one heating device 140 configured to heat at least a portion of the interior 106 of the housing 102. The at least one heating device 140 is configured to increase the temperature of the optical article 200 within the interior 106 of the housing 102 relative to ambient temperature surrounding the housing 102 in order to speed up the reverse transformation process of the photochromic compound(s) in the photochromic material from the activated (colored) state back to the unactivated (colorless) state and/or demonstrate the photochromic characteristics of the optical article 200 at different temperatures.

In some examples or aspects, the at least one heating device 140 may be configured to maintain a predetermined temperature within the interior 106 of the housing 102. For example, the at least one heating device 140 may be configured to maintain the interior 102 at a temperature in the range of 23° C.to 45° C., for example in the range of 37° C. to 39° C. In various examples or aspects, the at least one heating device 140 may be at least one of a conductive heating device, a convective heating device, or a radiative heating device. In some examples or aspects, the at least one heating device 140 may be configured to cool the interior 102. For example, the at least one heating device 140 may be a thermo-electric heating/cooling device that is capable of heating or cooling the interior 102.

With continued reference to FIG. 2, the at least one heating device 140 may have at least one heat source 142 and at least one fan 144. The at least one heat source 142 may be an electric heating element 146 thermally connected to a heat exchanger 148. The at least one fan 144 is configured to force air across the heat exchanger 148. Movement of air across the heat exchanger 148 heats the air. In some examples or aspects, the at least one heat source 142 may be configured for operating on a 12V DC power circuit. The at least one fan 144 may be a pair of fans, such as a pair of axial fans. In other examples or aspects, the at least one heating device 140 may be an infrared heating device, such as an infrared heating lamp.

With continued reference to FIG. 2, temperature of the heated air in the interior 106 of the housing 102 may be controlled by controlling the number and speed of the fans 144 and the number and output of the heating elements 146. A temperature control element 150, such as a thermistor, may be provided for actuating at least one of the heating elements 146 and the fans 144.

With continued reference to FIG. 2, the demonstration unit 100 has at least one control device 152 operatively connected to the activating light sources 136, the visible light source 134, the heating device 140, and the at least one light sensing device 160. In some examples or aspects, a single control device 152 may be configured to control each of the activating light sources 136, the visible light source 134, the heating device 140, and at least one light sensing device 160. In other examples or aspects, separate control devices 152 may be provided for each of the activating light sources 136, the visible light source 134, the heating device 140, and the at least one light sensing device 160. The at least one control device 152 may be configured to control at least one of an activation of the activating light source 136 or an intensity of the activating light source 136. The control device 152 may be further configured to control at least one of an activation of the visible light source 134 or an intensity of the visible light source 134. The control device 152 may be further configured to control at least one of an activation of the heating device 140 or a temperature of the heating device 140. The control device 152 may be further configured to control at least one of an activation of the visible light source 134 or an intensity of the visible light source 134 based on light characteristics sensed by the at least one light sensing device 160. The at least one control device 152 may be configured for operating on a 12V DC power circuit. In other examples or aspects, the at least one control device 152 may be configured for operating on a 110V or a 220V AC power circuit, and/or on battery power.

In some examples or aspects, the at least one control device 152 may be a microprocessor controller. The at least one control device 152 may be configured for pulse width modulated (PWM) operation, wherein analog operation of at least one of the activating light sources 136, the visible light source 134, the heating device 140, and light sensing device 160 can be achieved using digital control signals. In some examples or aspects, the at least one control device 152 may be configured for continuously modulated control of at least one of the activating light sources 136, the visible light source 134, or the heating device 140. For example, the at least one control device 152 may have a proportional-integral-derivative (PID) controller. Such PID controller operation may be based on light characteristics sensed by the at least one light sensing device 160. In other examples or aspects, the at least one control device 152 may be configured for pre-programmed control of at least one of the activating light sources 136, the visible light source 134, or the heating device 140. For example, the at least one control device 152 may have a timer configured for operating at least one of the activating light sources 136, the visible light source 134, or the heating device 140 for a predetermined duration based on predetermined criteria. The at least one control device 152 may have memory 153 configured for storing one or more predetermined spectral profiles corresponding to simulated outdoor lighting conditions, as discussed herein.

With continued reference to FIG. 2, the demonstration unit 100 has at least one user input device 154 configured for inputting user commands to control the operation of at least one of the activating light sources 136, the visible light source 134, or the heating device 140. The user input device 154 may include one or more devices capable of receiving information or input from the user. For example, the user input device 154 may include one or more buttons or switches 156. Alternatively or additionally, the user input device 154 may include one or more computing devices having an electronic visual display capable of displaying a graphical user interface (GUI), such as one or more monitors, touchscreens, or the like. Further, the user input device 154 may include or be in communication with one or more input devices capable of receiving input such as a touch screen display, a keyboard, a keypad, a mouse, a button, a switch, and/or the like. In some examples or aspects, the user input device 154 may be a remote device that is configured for wireless or wired communication with the demonstration unit 100. For example, the user input device 154 may be a remote computer device or mobile phone having an application configured for wireless communication (e.g. Wi-Fi, Bluetooth, or the like) or wired communication (e.g. Ethernet cable) with the demonstration unit 100.

In examples where the user input device 154 includes an electronic visual display, such visual display can be configured for receiving user input for controlling the operation of at least one of the activating light sources 136, the visible light source 134, or the heating device 140, and for communicating status information about an operating status or condition of the operation of at least one of the activating light sources 136, the visible light source 134, or the heating device 140. For example, the user input device 154 may be an LCD touchscreen used to input commands to control operation of at least one of the activating light sources 136, the visible light source 134, or the heating device 140. For example, the user may input commands to at least one activate/deactivate the activating light sources 136, control an intensity of the activating light source 136, activate/deactivate the visible light source 134, control an intensity of the visible light source 134, activate/deactivate the heating device 140, or control a temperature of the heating device 140. Furthermore, the user input device 154 that is configured as an LCD touchscreen may provide information regarding the operating status or condition of at least one of the activating light sources 136, the visible light source 134, or the heating device 140. For example, the LCD touchscreen may provide information regarding an active/inactive state of the activating light source 136, an intensity of the activating light sources 136, an active/inactive state of the visible light source 134, an intensity of the visible light source 134, an active/inactive state of the heating device 140, or a temperature of the heating device 140.

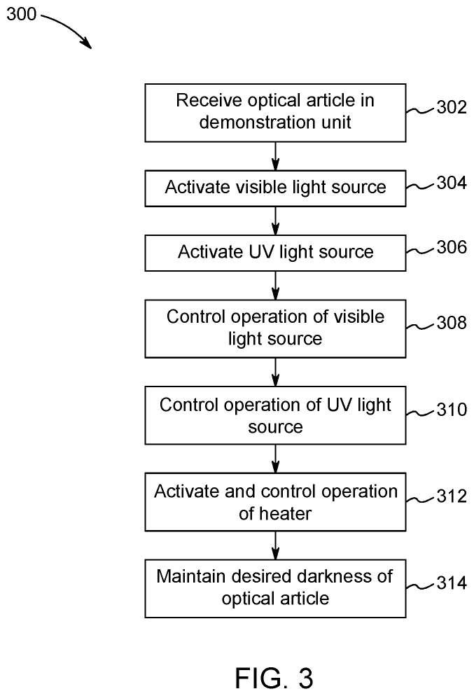

Having described the demonstration unit 100 with reference to FIGS. 1-2, an exemplary method 300 of using the demonstration unit 100 to demonstrate at least one photochromic characteristic of a photochromic optical article, such as the optical article 200 with a photochromic material, will now be described with reference to FIG. 3. In some examples or aspects, the demonstration unit 100 may be operated to activate at least one photochromic compound of the at least one photochromic material on the optical article 200 based on at least one predetermined spectral profile corresponding to a simulated outdoor lighting condition. In this manner, the optical article 200 having the at least one photochromic material can be displayed to a user as it would appear in a desired outdoor setting, such as, for example, on a cloudy day, or a sunny day with direct or indirect exposure to sunlight.

At step 302, one or more optical articles 200, such as one or more polymeric ophthalmic lenses having a photochromic material, are received within the interior 106 of the housing 102 of the demonstration unit 100. In some examples or aspects, the one or more optical articles 200 may be received within the interior 106 of the housing 102 by moving the drawer 120 from the closed position to an open position and placing one or more optical articles 200 on the inspection platform 124. For example, the bottom surface of each optical article 200 may be supported on the support surface 132 of the inspection platform 124. The drawer 120 may then be moved from the open position to the closed position to move the one or more optical articles 200 into the interior 106 of the housing 102.

After receiving the optical articles 200 within the interior 106 of the housing 102, the at least one visible light source 134 and the at least one activating light source 136 may be activated at steps 304 and 306, respectively. In order to activate the photochromic compound(s) in the photochromic material of the optical article 200 (i.e, transition from colorless to colored), at least a portion of the optical article 200 having the photochromic material is irradiated with electromagnetic energy of appropriate wavelength to cause activation. Irradiation of the optical article 200 with ultraviolet light from the at least one activating light source 136 causes a reversible transformation of color of the optical article 200 due to activation of the photochromic compound(s) in the photochromic material of the optical article 200. Activation of the at least one visible light source 134 and the at least one activating light source 136 may be controlled by the at least one control device 152, such as by receiving user input to activate the at least one visible light source 134 and the at least one activating light source 136 on the user input device 154.

Upon activation of the at least one visible light source 134 and the at least one activating light source 136, operation of the at least one visible light source 134 and the at least one activating light source 136 at steps 308 and 310, respectively, may be controlled to activate the photochromic compound of the at least one photochromic material on the optical article 200 based on at least one predetermined spectral profile corresponding to a simulated outdoor lighting condition. With photochromic dyes activating within defined ranges of the UV wavelength, controlling the duration and output (intensity) of the at least one activating light source 136 allows the control over the amount of activation that occurs. The intensity of the at least one activating light source 136 can be controlled by a PWM (pulse width modulation) signal using the at least one control device 152. This signal can be provided at an interval where the output of the at least one activating light source 136 does not reach a peak rated output. With a combination of duration, intensity, and knowing the response of the photochromic dye to UV, a “recipe” can be developed to mimic different outdoor lighting conditions depending on weather, location and temperature. Measurements of actual outdoor lighting conditions, such as brightness and UV irradiance, may be collected in a variety of lighting conditions (e.g., full sun, partial sun, clouds), at different times of day (e.g., morning, mid-day, evening), at different geographic locations, and/or different times of the year. Spectral profiles of such measurements may be used to simulate the outdoor lighting conditions based on controlling the activation and intensity of the at least one visible light source 134 and the at least one activating light source 136. A plurality of different predetermined spectral profiles may be stored on the at least one control device 152, such as in the memory 153 of the at least one control device 152. In this manner, if the user desires to view the optical article 200 inside the housing 102 of the demonstration unit 100 as the optical article 200 would appear in various outdoor lighting conditions, the user may select one of the plurality of different spectral profiles to activate the at least one visible light source 134 and the at least one activating light source 136 in order to activate the photochromic compound of the at least one photochromic material on the optical article 200, and thereby make the optical article 200 appear as it would under desired outdoor lighting conditions.

For example, the user may desire to view the optical article 200 placed in the demonstration unit 100 as the optical article 200 would appear in direct sunlight at noon. The user may select, via the user input device 154, a predetermined spectral profile that, based on controlled operation of the at least one visible light source 134 and the at least one activating light source 136 via the at least one control device 152, would activate the photochromic compound of the at least one photochromic material on the optical article 200 and make the optical article 200 appear in the demonstration unit 100 as it would in the desired outdoor lighting conditions (i.e., direct sunlight at noon). Based upon the user's selection of the simulated outdoor lighting conditions under which the optical article 200 is to be viewed, the at least one control device 152 may control the operation of at least one visible light source 134 and the at least one activating light source 136. For example, the at least one control device 152 may operate a first activating light source 136₁ at a first intensity and operate a second activating light source 136₂ at a second intensity that may be the same or different that the first intensity. In order to overcome the blue light that is commonly radiated by activating light sources, the at least one control device 152 may operate the at least one visible light source 134 at a third intensity. In some embodiments or aspects, the at least one control device 152 may further activate and control the operation of the at least one heating device 140 at step 312 to control the temperature in the interior of the demonstration unit 100.

At step 314, the at least one control device 152 may be configured to maintain a desired darkness of the optical article 200 that corresponds to the darkness at the simulated outdoor lighting condition. For example, the at least one control device 152 may be configured to control the activation of the at least one visible light source 134 and the at least one activating light source 136 based on light characteristics sensed by the light sensing device 160. For example, when the at least one light sensing device 160 senses that amount of visible light that passes through the optical article 200 is below a predetermined threshold, which indicates a darkness of the optical article 200, the at least one control device 152 may, for example, turn off at least one of the at least one visible light source 134 and the at least one activating light source 136 in order to cause the photochromic compound of the at least one photochromic material on the optical article 200 to deactivate, and thereby lighten the color of the optical article 200. In some examples or aspects, the at least one control device 152 may further control the operation of the at least one heating device 140 based on light characteristics sensed by the light sensing device 160 to control the speed of the reversible transformation of the color of the optical article 200 from dark to light.

In some examples or aspects, the at least one control device 152 may control the activation of at least one of the activating light sources 136, the visible light source 134, or the heating device 140 based on a timer. For example, the at least one control device 152 configured for operating at least one of the activating light sources 136, the visible light source 134, or the heating device 140 for a predetermined duration based on predetermined criteria.

It will be readily appreciated by those skilled in the art that various modifications, as indicated above, may be made to the disclosure without departing from the concepts disclosed in the foregoing description. Accordingly, the particular examples or aspects described in detail herein are illustrative only and are not limiting to the scope of the disclosure, which is to be given the full breadth of the appended claims and any and all equivalents thereof.

1. A demonstration unit for demonstrating at least one photochromic characteristic of an optical article having at least one photochromic material, the demonstration unit comprising:
a housing defining an interior;
at least two activating light sources configured to radiate ultraviolet light into the interior of the housing;
at least one visible light source configured to illuminate at least a portion of the interior of the housing; and
a control device operatively connected to the at least two activating light sources and the at least one visible light source,
wherein the control device is configured to control operation of the at least two activating light sources and the at least one visible light source to activate at least one photochromic compound of the at least one photochromic material based on at least one predetermined spectral profile corresponding to a simulated outdoor lighting condition.

2. The demonstration unit according to claim 1, wherein the at least one predetermined spectral profile corresponding to the simulated outdoor lighting condition is generated by individually controlling each of the at least two activating light sources and the at least one visible light source.

3. The demonstration unit according to claim 1, wherein the control device is configured to control an activation of the at least two activating light sources and the at least one visible light source.

4. The demonstration unit according to claim 1, wherein the control device is configured to control an intensity of the at least two activating light sources and the at least one visible light source.

5. The demonstration unit according to claim 1, wherein each of the at least two activating light sources is configured to emit a different spectral output in an ultraviolet light spectrum.

6. The demonstration unit according to claim 5, wherein each of the at least two activating light sources is an ultraviolet light emitting diode.

7. The demonstration unit according to claim 1, further comprising a light sensing device operatively connected with the control device, wherein the control device is configured to control operation of the at least two activating light sources and the at least one visible light source based on light characteristics sensed by the light sensing device.

8. The demonstration unit according to claim 7, wherein the light sensing device is a photodiode.

9. The demonstration unit according to claim 1, further comprising an inspection platform within the interior of the housing configured for supporting at least a portion of the optical article.

10. The demonstration unit according to claim 1, further comprising at least one heating device configured to heat at least a portion of the interior of the housing.

11. The demonstration unit according to claim 10, wherein the at least one heating device comprises at least one heat source and at least one fan.

12. The demonstration unit according to claim 1, wherein the housing comprises a door for enclosing the interior of the housing.

13. A method of demonstrating at least one photochromic characteristic of an optical article having at least one photochromic material, the method comprising:
receiving the optical article within an interior of a housing of a demonstration unit;
activating at least one activating light source to irradiate at least a portion of the optical article with ultraviolet light;
activating at least one visible light source to irradiate at least a portion of the optical article with visible light; and
controlling, using a control device, operation of the at least two activating light sources and the at least one visible light source to activate a photochromic compound of the at least one photochromic material based on at least one predetermined spectral profile corresponding to a simulated outdoor lighting condition.

14. The method according to claim 13, wherein controlling the operation of the at least two activating light sources and the at least one visible light source comprises individually controlling an activation of the at least two activating light sources and the at least one visible light source, and an intensity of the at least two activating light sources and the at least one visible light source of the at least two activating light sources and the at least one visible light source.

15. The method according to claim 13, further comprising heating at least a portion of the interior of the housing with a heating device.
